(19) United States
(12) Patent Application Publication
(10) Pub. No.: US 2015/0279591 A1
(43) Pub. Date: Oct. 1, 2015

(54) KEY STRUCTURE AND KEYBOARD STRUCTURE

(71) Applicant: SILITECH TECHNOLOGY CORP., New Taipei City (TW)

(72) Inventors: LONG-JYH PAN, New Taipei City (TW); YEN-CHIH LIN, Taipei City (TW)

(73) Assignee: SILITECH TECHNOLOGY CORP., New Taipei City (TW)

(21) Appl. No.: 14/269,126

(22) Filed: May 3, 2014

(30) Foreign Application Priority Data
Mar. 28, 2014 (TW) 103205403

(51) Int. Cl. H01H 13/85; H01H 13/83; H01H 13/14; H01H 13/7065; H01H 13/704; H01H 13/10

(52) U.S. Cl. CPC H01H 13/85; H01H 13/704; H01H 13/10; H01H 13/14; H01H 13/7065; H01H 13/83; H01H 2221/058; H01H 2219/062; H01H 2219/06

(57) ABSTRACT

A key structure includes a switch circuit, a frame layer, a deformable elastic element and a pressing unit. The switch circuit has a predetermined pressing region. The frame layer is disposed on the switch circuit, and the frame layer has a receiving space. The deformable elastic element is disposed on the switch circuit and received in the receiving space of the frame layer. The pressing unit includes a key body contacting the deformable elastic element. The deformable elastic element is disposed between the switch circuit and the key body, and the contact area between the deformable elastic element and the switch circuit is smaller than the contact area between the deformable elastic element and the key body. Whereby, when a predetermined pressure is pressed upon the pressing unit, the predetermined pressure is balancedly pressed on the predetermined pressing region of the switch circuit through the deformable elastic element.

### BACKGROUND OF THE INVENTION

1. Field of the Invention

The instant disclosure relates to a key structure and a keyboard structure, and a key structure and a keyboard structure for increasing the pressing feeling of equilibrium.

2. Description of Related Art

Keyboards are popular input device for people in information processing unit such as computer and apparatus requiring frequent input such as cash register. Therefore, the keyboards are under extensive research to provide better performance such as good tactile feel, movement, sound and balance. Conventional keyswitches with lever mechanism (such as scissors type keyswitch) are extensively used in keyboard for notebook computer. However, the keyswitch with larger keycap (such as double cap size or triple cap size) has the problem of tilt key cap because larger size and unbalance force (force not at the center of the keycap). The keyswitch with larger key cap are liable to malfunction or the data cannot be exactly input. To overcome this problem, a resilient metal balance rod is provided between the cap and the base of the keyswitch.

### SUMMARY OF THE INVENTION

One aspect of the instant disclosure relates to a key structure and a keyboard structure for increasing the pressing feeling of equilibrium.

One of the embodiments of the instant disclosure provides a key structure for increasing the pressing feeling of equilibrium, comprising: a switch circuit, a frame layer, a deformable elastic element and a pressing unit. The switch circuit has a predetermined pressing region. The frame layer is disposed on the switch circuit, wherein the frame layer has a receiving space. The deformable elastic element is disposed on the switch circuit and received in the receiving space of the frame layer. The pressing unit includes a key body contacting the deformable elastic element. The deformable elastic element is disposed between the switch circuit and the key body, and the contact area between the deformable elastic element and the switch circuit is smaller than the contact area between the deformable elastic element and the key body. Whereby, when a predetermined pressure is pressed upon the pressing unit, the predetermined pressure is balancedly pressed on the predetermined pressing region of the switch circuit through the deformable elastic element.

Another one of the embodiments of the instant disclosure provides a keyboard structure for increasing the pressing feeling of equilibrium, comprising: a switch circuit, a frame layer, a plurality of deformable elastic elements and a pressing unit. The switch circuit has a plurality of predetermined pressing regions. The frame layer is disposed on the switch circuit, wherein the frame layer has a plurality of receiving spaces. The deformable elastic elements are disposed on the switch circuit and respectively received in the receiving spaces of the frame layer. The pressing unit includes a plurality of key bodies respectively contacting the deformable elastic elements. Each of the deformable elastic elements is disposed between the switch circuit and the corresponding key body, and the contact area between the deformable elastic element and the switch circuit is smaller than the contact area between the deformable elastic element and the key body. Whereby, when a predetermined pressure is pressed upon the pressing unit, the predetermined pressure is balancedly pressed on the corresponding predetermined pressing region of the switch circuit through the corresponding deformable elastic element.

Yet another one of the embodiments of the instant disclosure provides a keyboard structure for increasing the pressing feeling of equilibrium, comprising: a switch circuit, a frame layer, a plurality of deformable elastic elements and a pressing unit. The switch circuit has a plurality of predetermined pressing regions. The frame layer is disposed on the switch circuit, wherein the frame layer has a plurality of receiving spaces. The deformable elastic elements are disposed on the switch circuit and respectively received in the receiving spaces of the frame layer. The pressing unit includes a plurality of key bodies respectively contacting the deformable elastic elements. Each of the deformable elastic elements is disposed between the switch circuit and the corresponding key body, and the contact area between the deformable elastic element and the switch circuit is smaller than the contact area between the deformable elastic element and the key body. Each of the deformable elastic elements is a metal dome or a rubber dome reversely disposed on the switch circuit, and each of the deformable elastic elements has a wide top portion for contacting the corresponding key body and a narrow bottom portion opposite to the wide top portion for contacting the corresponding predetermined pressing region of the switch circuit. Whereby, when a predetermined pressure is pressed upon the pressing unit, the predetermined pressure is balancedly pressed on the corresponding predetermined pressing region of the switch circuit through the corresponding deformable elastic element.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1A shows a lateral, cross-sectional, schematic view of the key structure according to the first embodiment of the instant disclosure;

FIG. 1B shows a lateral, cross-sectional, schematic view of the switch circuit of the key structure according to the first embodiment of the instant disclosure;

FIG. 2 shows a lateral, cross-sectional, schematic view of the key structure according to the second embodiment of the instant disclosure;

FIG. 3 shows a lateral, cross-sectional, schematic view of the key structure according to the third embodiment of the instant disclosure;

FIG. 4 shows a lateral, cross-sectional, schematic view of the key structure according to the fourth embodiment of the instant disclosure;

FIG. 5 shows a lateral, cross-sectional, schematic view of the keyboard structure according to the fifth embodiment of the instant disclosure;

FIG. 6 shows a lateral, cross-sectional, schematic view of the keyboard structure according to the sixth embodiment of the instant disclosure;

FIG. 7 shows a lateral, cross-sectional, schematic view of the keyboard structure according to the seventh embodiment of the instant disclosure;

FIG. 8 shows a lateral, cross-sectional, schematic view of the keyboard structure according to the eighth embodiment of the instant disclosure;

FIG. 9 shows a lateral, cross-sectional, schematic view of the key structure according to the ninth embodiment of the instant disclosure;

FIG. 10 shows a lateral, cross-sectional, schematic view of the key structure according to the tenth embodiment of the instant disclosure;

FIG. 11 shows a lateral, cross-sectional, schematic view of the keyboard structure according to the eleventh embodiment of the instant disclosure; and

FIG. 12 shows a lateral, cross-sectional, schematic view of the keyboard structure according to the twelfth embodiment of the instant disclosure.

### DETAILED DESCRIPTION OF THE PREFERRED EMBODIMENTS

### First Embodiment

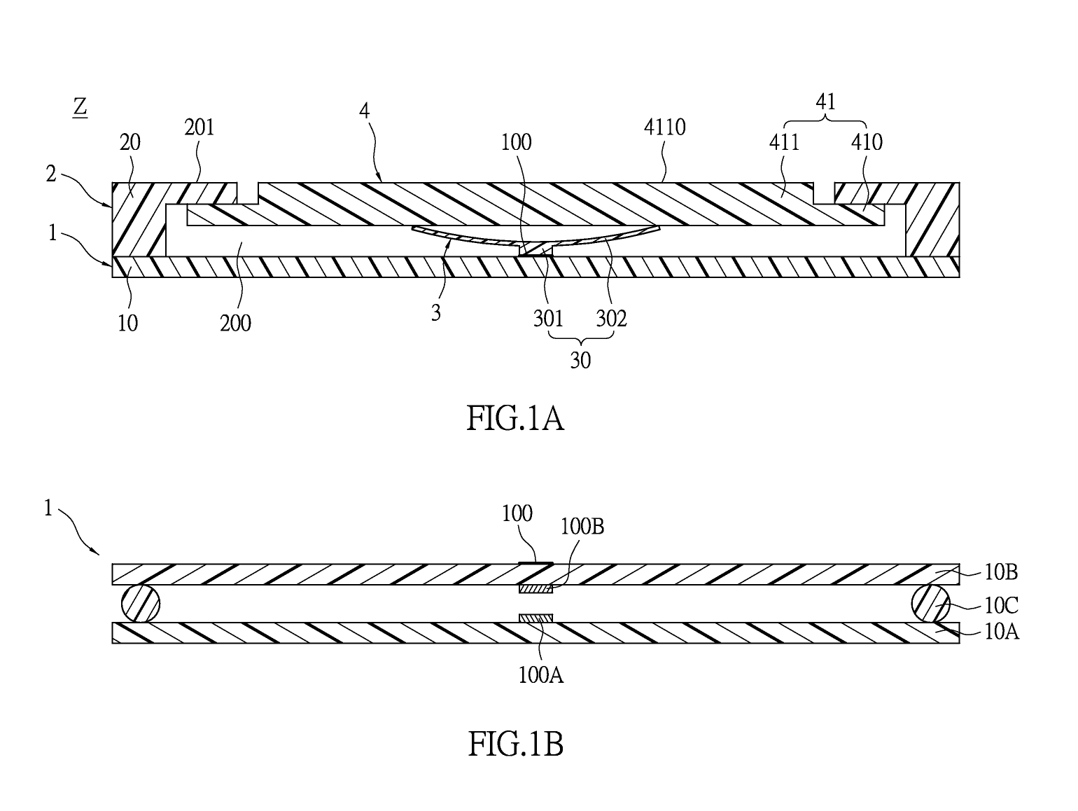

Referring to FIG. 1A and FIG. 1B, the first embodiment of the instant disclosure provides a key structure Z for increasing the pressing feeling (or pressing sense) of equilibrium, comprising: a circuit unit 1, a frame unit 2, an elastic unit 3 and a pressing unit 4.

First, referring to FIG. 1A and FIG. 1B, the circuit unit 1 includes a switch circuit 10, and the switch circuit 10 has a predetermined pressing region 100 disposed on the top side of the switch circuit 10. For example, the switch circuit 10 may be a membrane switch circuit. More precisely, referring to FIG. 1B, the switch circuit 10 includes a first insulating layer 10A, a second insulating layer 10B disposed above the first insulating layer 10A, and a plurality of spacers 10C disposed between the first insulating layer 10A and the second insulating layer 10B. The first insulating layer 10A has a first conductive portion 100A disposed on the top side of the first insulating layer 10A, the second insulating layer 10B has a second conductive portion 100B disposed on the bottom side of the second insulating layer 10B and corresponding to the first conductive portion 100A, and the predetermined pressing region 100 of the switch circuit 10 is disposed on the top side of the second insulating layer 10B and corresponding to the second conductive portion 100B.

Moreover, as shown in FIG. 1A, the frame unit 2 includes a frame layer 20 disposed on the switch circuit 10, and the frame layer 20 has a receiving space 200 passing through the frame layer 20. In addition, the elastic unit 3 includes a deformable elastic element (component) 30 disposed on the switch circuit 10 and received in the receiving space 200 of the frame layer 20, and the deformable elastic element 30 has a convex portion 301 downwardly protruded from the deformable elastic element 30 and corresponding to the predetermined pressing region 100 and a surrounding portion 302 upwardly and outwardly extended from the convex portion 301. For example, the deformable elastic element 30 may be a metal dome or a rubber dome reversely disposed on the switch circuit 10, and the deformable elastic element 30 has a wide top portion for contacting a key body 40 of the pressing unit 4 and a narrow bottom portion opposite to the wide top portion for contacting the predetermined pressing region 100 of the switch circuit 10. The cross-sectional view of the metal dome or the rubber dome also may be shown as a W-shaped design, and the W-shaped design of the metal dome or the rubber dome has an upward opening. In addition, the convex portion 301 of the deformable element 30 may be a solid cylinder for abutting against the predetermined pressing region 100, the surrounding portion 302 of the deformable elastic element 30 may be a bowl elastic body for moving the convex portion 301 to press the predetermined pressing region 100, and the bowl elastic body has an opening directly facing the frame layer 20.

Furthermore, as shown in FIG. 1A, the pressing unit 4 includes a key body 41 (such as a hard key body) received inside the receiving space 200 for contacting the surrounding portion 302 of the deformable elastic element 30. More precisely, the key body 41 has a first key portion 410 for contacting the surrounding portion 302 and a second key portion 411 connected to the first key portion 410 and exposed from the frame layer 20, and the deformable elastic element 30 is disposed between the switch circuit 10 and the key body 41. Because the deformable elastic element 30 is reversely disposed on the switch circuit 10 and the deformable elastic element 30 is disposed between the switch circuit 10 and the key body 41, the contact area between the narrow bottom portion of the deformable elastic element 30 and the switch circuit 10 is smaller than the contact area between the wide top portion of the deformable elastic element 30 and the key body 41. Whereby, when a user uses a predetermined pressure to press upon the second key portion 411 of the key body 41, the predetermined pressure is balancedly or averagely pressed on the predetermined pressing region 100 of the switch circuit 10 through the deformable elastic element 30, for increasing the pressing feeling of equilibrium during the process of pressing the second key portion 411 of the key body 41. In addition, when the second key portion 411 of the key body 41 is pressed by the user, the second conductive layer 100B of the second insulating layer 10B is downwardly moved to electrically connect to the first conductive layer 100A of the first insulating layer 10A.

### Second Embodiment

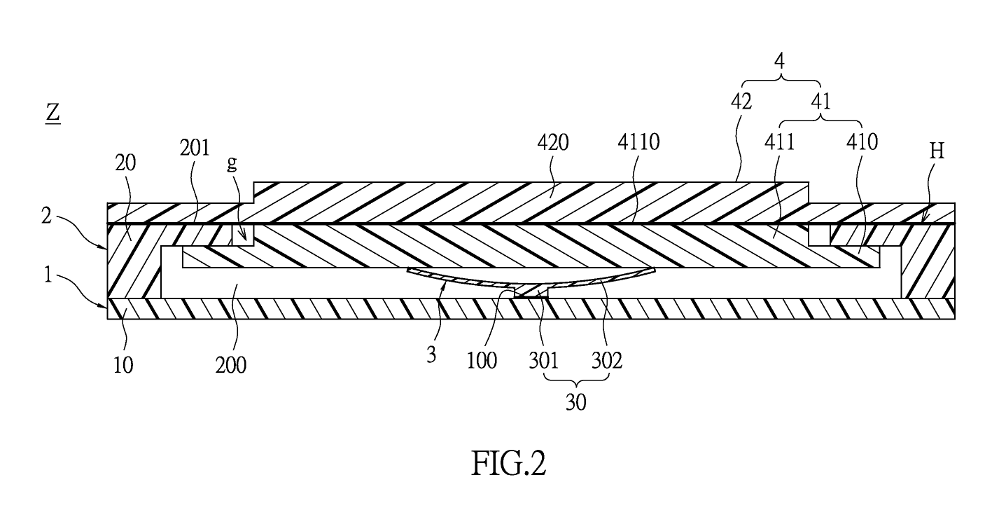

Referring to FIG. 2, the second embodiment of the instant disclosure provides a key structure Z for increasing the pressing feeling of equilibrium. Comparing FIG. 2 with FIG. 1A, the difference between the second embodiment and the first embodiment is as follows: in the second embodiment, the pressing unit 4 includes a key layer 42 (such as a flexible key layer) disposed on the frame layer 20 and the key body 41 for enclosing a gap g between the frame layer 20 and the key body 41. The top side 201 of the frame layer 20 and the top side 4110 of the key body 41 are substantially flushed with each other, and the key layer 42 is connected to the frame layer 20 and the key body 41 through adhesive glue H to form a single module component composed of the key layer 42, the frame layer 20 and the key body 41. More precisely, the key body 41 has a first key portion 410 for contacting the surrounding portion 302 and a second key portion 411 connected to the first key portion 410 and disposed between the first key portion 410 and the key layer 42, and the key layer 42 has a pressing convex portion 420 disposed on the top side of the key layer 42 and corresponding to the second key portion 411.

### Third Embodiment

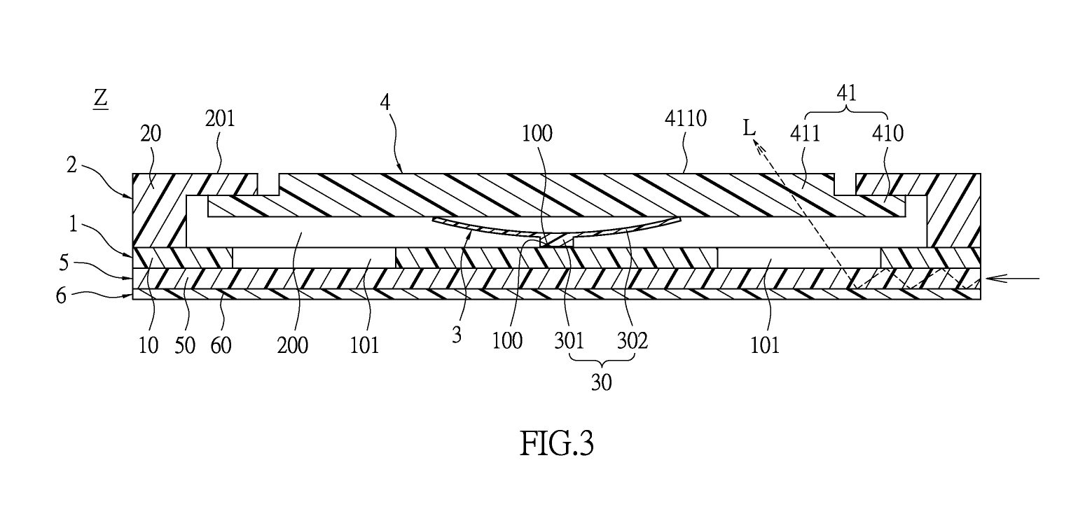

Referring to FIG. 3, the third embodiment of the instant disclosure provides a key structure Z for increasing the pressing feeling of equilibrium. Comparing FIG. 3 with FIG. 1A, the difference between the third embodiment and the first embodiment is as follows: the key structure Z of the third embodiment further comprises a light-guiding unit 5 and a light-reflecting unit 6. The light-guiding unit 5 includes a light-guiding layer 50 disposed on the bottom side of the switch circuit 10, and the light-reflecting unit 6 includes a light-reflecting layer 60 disposed on the bottom side of the light-guiding layer 50. Whereby, light beams L inside the light-guiding layer 50 can sequentially pass through the light-transmitting switch circuit 10 and the key body 41. It is worth mentioning that the switch circuit 10 may be a special design having a plurality of through openings 101 passing through the switch circuit 10 and communicated with the receiving space 200.

### Fourth Embodiment

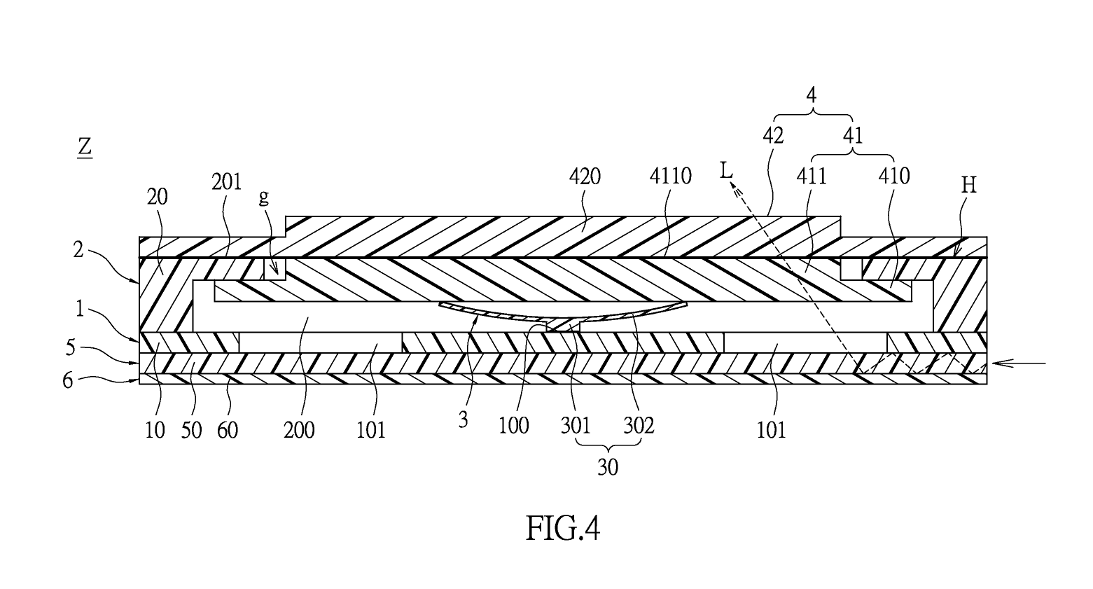

Referring to FIG. 4, the fourth embodiment of the instant disclosure provides a key structure Z for increasing the pressing feeling of equilibrium. Comparing FIG. 4 with FIG. 2, the difference between the fourth embodiment and the second embodiment is as follows: the key structure Z of the fourth embodiment further comprises a light-guiding unit 5 and a light-reflecting unit 6. The light-guiding unit 5 includes a light-guiding layer 50 disposed on the bottom side of the switch circuit 10, and the light-reflecting unit 6 includes a light-reflecting layer 60 disposed on the bottom side of the light-guiding layer 50. Whereby, light beams L inside the light-guiding layer 50 can sequentially pass through the light-transmitting switch circuit 10 and the key body 41 and are transmitted to the key layer 42. It is worth mentioning that the switch circuit 10 may be a special design having a plurality of through openings 101 passing through the switch circuit 10 and communicated with the receiving space 200.

### Fifth Embodiment

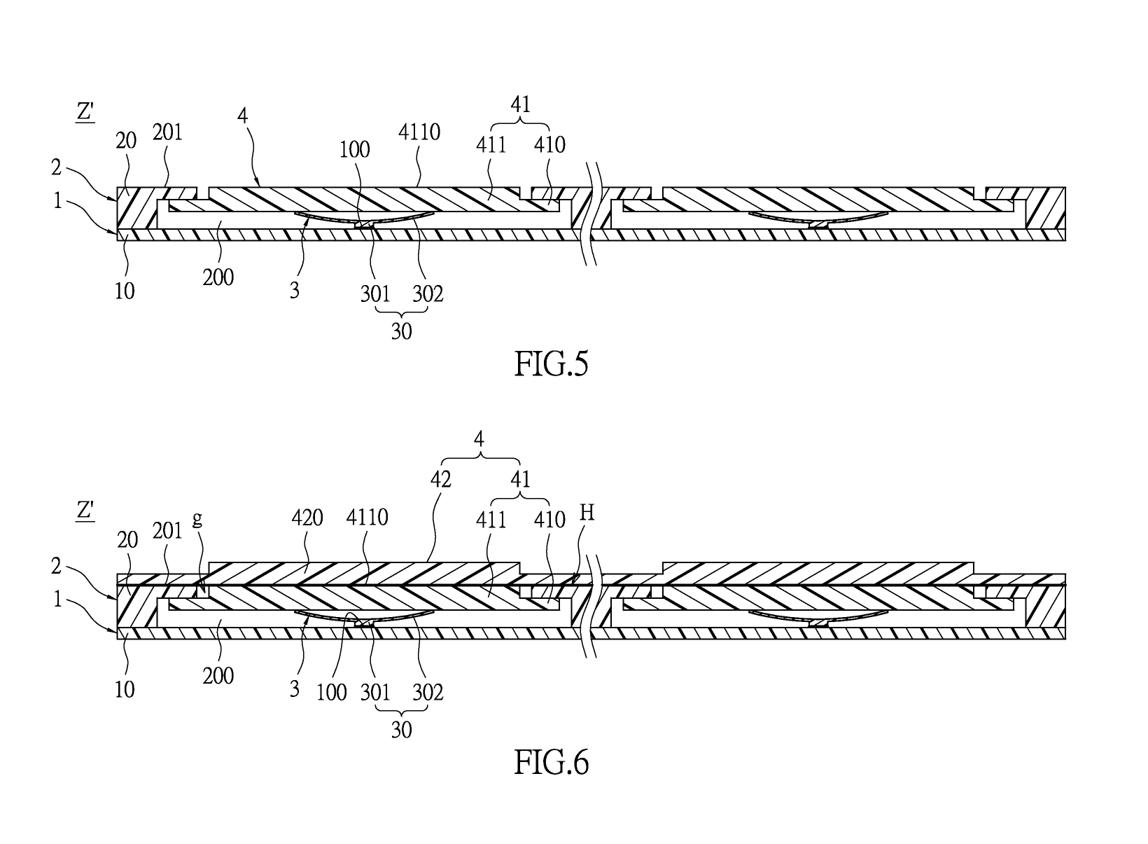

Referring to FIG. 5, the fifth embodiment of the instant disclosure provides a keyboard structure Z′ for increasing the pressing feeling of equilibrium. Comparing FIG. 5 with FIG. 1A, the difference between the fifth embodiment and the first embodiment is as follows: in the fifth embodiment, the switch circuit 10 has a plurality of predetermined pressing regions 100 on the top side of the switch circuit 10, and the frame layer 20 has a plurality of receiving spaces 200 passing therethrough. The elastic unit 3 includes a plurality of deformable elastic elements 30 disposed on the switch circuit 10 and respectively received in the receiving spaces 200 of the frame layer 20, and each of the deformable elastic elements 30 has a convex portion 301 downwardly protruded therefrom and corresponding to the corresponding predetermined pressing region 100 and a surrounding portion 302 upwardly and outwardly extended from the convex portion 301. The pressing unit 4 includes a plurality of key bodies 41 respectively disposed inside the receiving spaces 200 for respectively contacting the deformable elastic elements 302.

More precisely, each of the deformable elastic elements 30 may be a metal dome or a rubber dome reversely disposed on the switch circuit 10, and each of the deformable elastic elements 30 has a wide top portion for contacting the corresponding key body 41 and a narrow bottom portion opposite to the wide top portion for contacting the corresponding predetermined pressing region 100 of the switch circuit 10. In addition, the convex portion 301 of each deformable element 30 may be a solid cylinder for abutting against the corresponding predetermined pressing region 100, and the surrounding portion 302 of each deformable elastic element 30 may be a bowl elastic body for moving the convex portion 301 to press the corresponding predetermined pressing region 100.

Because the deformable elastic elements 30 are reversely disposed on the switch circuit 10 and each of the deformable elastic elements 30 is disposed between the switch circuit 10 and the corresponding key body 41, the contact area between the narrow bottom portion of the deformable elastic element 30 and the switch circuit 10 is smaller than the contact area between the wide top portion of the deformable elastic element 30 and the key body 41. Whereby, when a user uses a predetermined pressure to press upon the second key portion 411 of the key body 41, the predetermined pressure is balancedly or averagely pressed on the corresponding predetermined pressing region 100 of the switch circuit 10 through the corresponding deformable elastic element 30, for increasing the pressing feeling of equilibrium during the process of pressing the second key portion 411 of the key body 41.

### Sixth Embodiment

Referring to FIG. 6, the sixth embodiment of the instant disclosure provides a keyboard structure Z′ for increasing the pressing feeling of equilibrium. Comparing FIG. 6 with FIG. 5, the difference between the sixth embodiment and the fifth embodiment is as follows: in the sixth embodiment, the pressing unit 4 further includes a key layer 42 disposed on the frame layer 20 and the key bodies 41 for enclosing gaps g between the frame layer 20 and the key body 41. In addition, the top side 201 of the frame layer 20 and the top sides 4110 of the key bodies 41 are substantially flushed with each other, and the key layer 42 is connected to the frame layer 20 and the key bodies 41 through adhesive glue H to form a single module component composed of the key layer 42, the frame layer 20 and the key bodies 41. More precisely, each key body 41 has a first key portion 410 for contacting the corresponding surrounding portion 302 and a second key portion 411 connected to the first key portion 410 and disposed between the first key portion 410 and the key layer 42, and the key layer 42 has a plurality of pressing convex portions 420 disposed on the top side thereof and respectively corresponding to the second key portions 411 of the key bodies 41.

### Seventh Embodiment

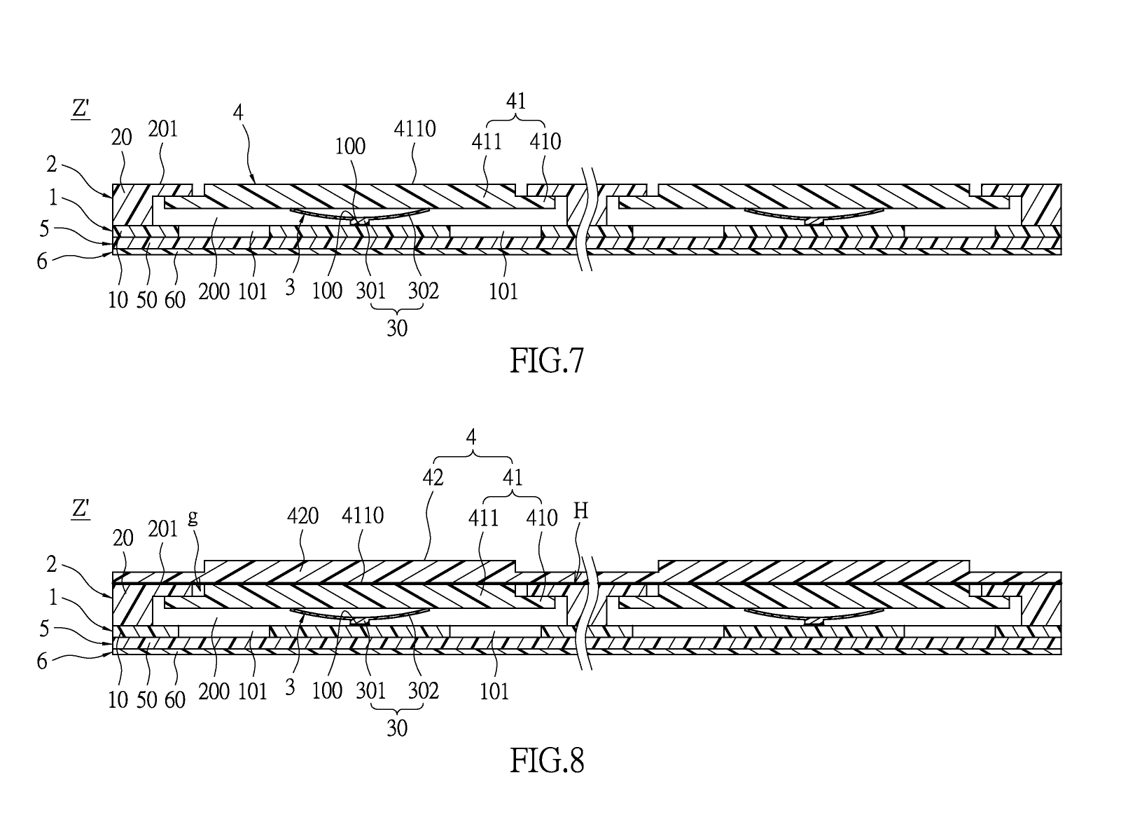

Referring to FIG. 7, the seventh embodiment of the instant disclosure provides a keyboard structure Z′ for increasing the pressing feeling of equilibrium. Comparing FIG. 7 with FIG. 5, the difference between the seventh embodiment and the fifth embodiment is as follows: the keyboard structure Z′ of the seventh embodiment further comprises: a light-guiding unit 5 and a light-reflecting unit 6. The light-guiding unit 5 includes a light-guiding layer 50 disposed on the bottom side of the switch circuit 10, and the light-reflecting unit 6 includes a light-reflecting layer 60 disposed on the bottom side of the light-guiding layer 50. Whereby, light beams L inside the light-guiding layer 50 can sequentially pass through the switch circuit 10 and the key bodies 41. It is worth mentioning that the switch circuit 10 may be a special design having a plurality of through openings 101 passing through the switch circuit 10 and communicated with the receiving space 200.

### Eighth Embodiment

Referring to FIG. 8, the seventh embodiment of the instant disclosure provides a keyboard structure Z′ for increasing the pressing feeling of equilibrium. Comparing FIG. 8 with FIG. 6, the difference between the eighth embodiment and the sixth embodiment is as follows: the keyboard structure Z′ of the eighth embodiment further comprises: a light-guiding unit 5 and a light-reflecting unit 6. The light-guiding unit 5 includes a light-guiding layer 50 disposed on the bottom side of the switch circuit 10, and the light-reflecting unit 6 includes a light-reflecting layer 60 disposed on the bottom side of the light-guiding layer 50. Whereby, light beams L inside the light-guiding layer 50 can sequentially pass through the switch circuit 10 and the key bodies 41 and are transmitted to the key layer 42. It is worth mentioning that the switch circuit 10 may be a special design having a plurality of through openings 101 passing through the switch circuit 10 and communicated with the receiving space 200.

### Ninth Embodiment

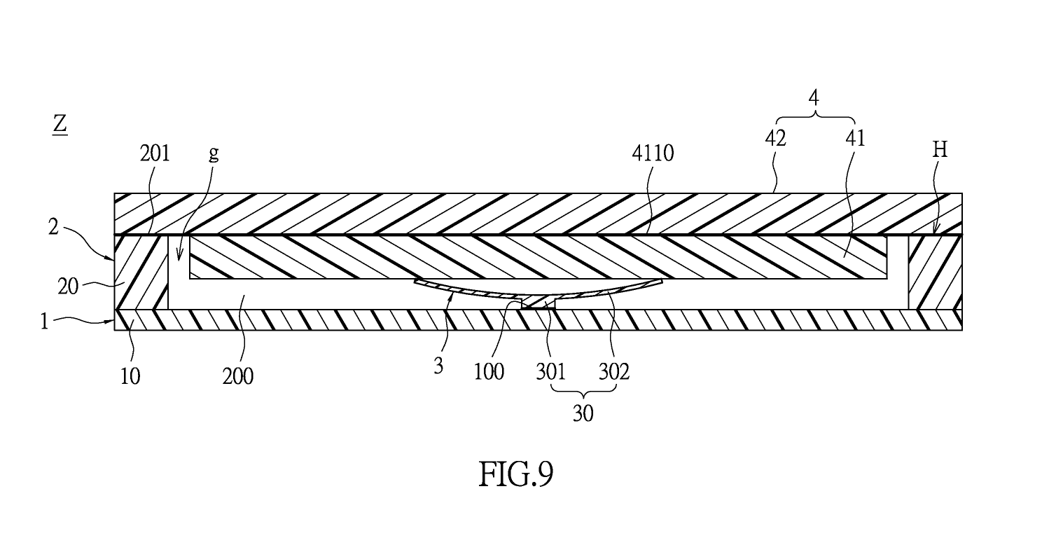

Referring to FIG. 9, the ninth embodiment of the instant disclosure provides a key structure Z for increasing the pressing feeling of equilibrium. Comparing FIG. 9 with FIG. 2, the difference between the ninth embodiment and the second embodiment is as follows: the frame layer 20 of the ninth embodiment is shown as a simple horizontal shape (as shown in FIG. 9), but the frame layer 20 of the second embodiment is shown as an inward bending shape (as shown in FIG. 2). In addition, the key body 41 of the ninth embodiment may be one of the first key portion 410 and the second key portion 411 of the key body 41 of the second embodiment, thus the thickness of the key body 41 of the ninth embodiment is certainly smaller than that of the key body 41 of the second embodiment.

### Tenth Embodiment

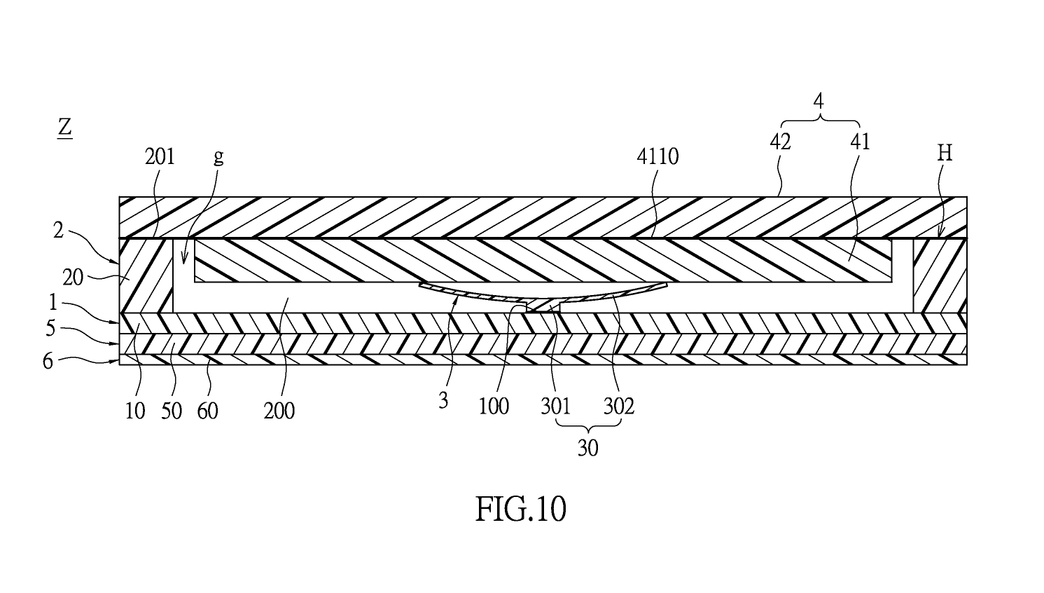

Referring to FIG. 10, the tenth embodiment of the instant disclosure provides a key structure Z for increasing the pressing feeling of equilibrium. Comparing FIG. 10 with FIG. 9, the difference between the tenth embodiment and the ninth embodiment is as follows: the key structure Z of the tenth embodiment further comprises a light-guiding unit 5 and a light-reflecting unit 6. The light-guiding unit 5 includes a light-guiding layer 50 disposed on the bottom side of the switch circuit 10, and the light-reflecting unit 6 includes a light-reflecting layer 60 disposed on the bottom side of the light-guiding layer 50. Whereby, light beams (not shown) inside the light-guiding layer 50 can sequentially pass through the light-transmitting switch circuit 10 and the key body 41 and are transmitted to the key layer 42.

### Eleventh Embodiment

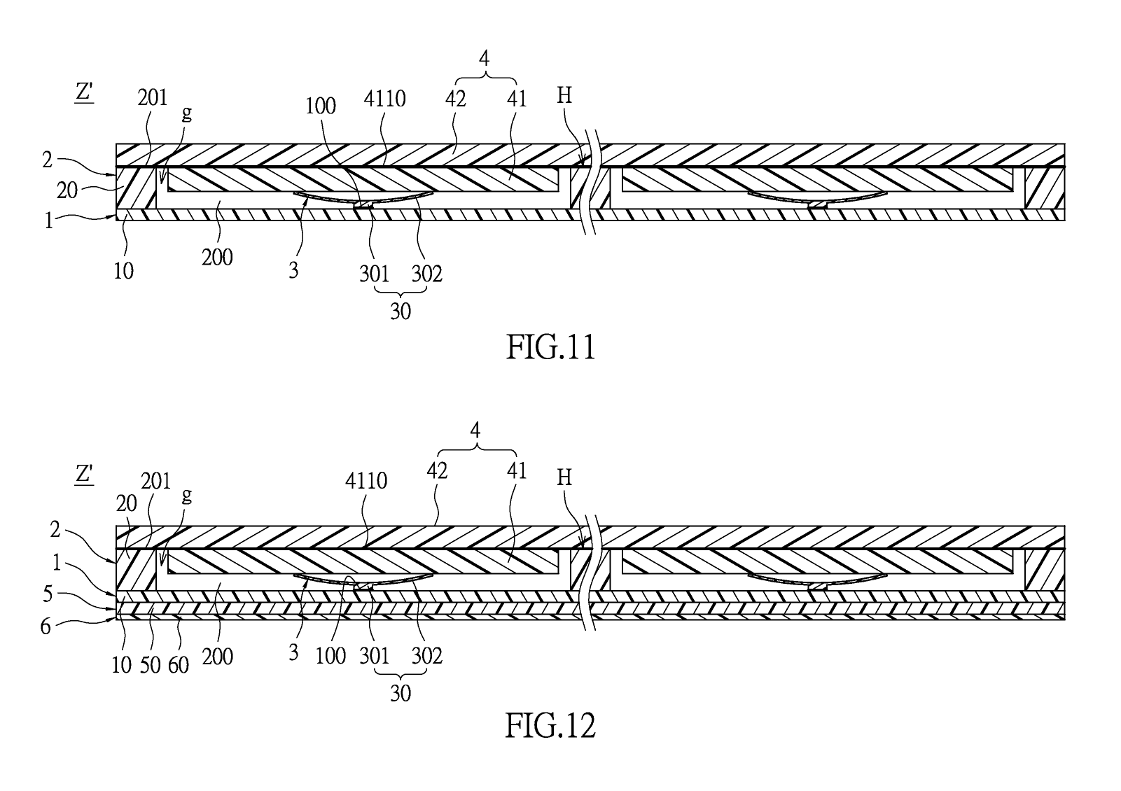

Referring to FIG. 11, the eleventh embodiment of the instant disclosure provides a keyboard structure Z′ for increasing the pressing feeling of equilibrium. Comparing FIG. 11 with FIG. 9, the difference between the eleventh embodiment and the ninth embodiment is as follows: in the eleventh embodiment, the switch circuit 10 has a plurality of predetermined pressing regions 100 on the top side of the switch circuit 10, and the frame layer 20 has a plurality of receiving spaces 200 passing therethrough. The elastic unit 3 includes a plurality of deformable elastic elements 30 disposed on the switch circuit 10 and respectively received in the receiving spaces 200 of the frame layer 20, and each of the deformable elastic elements 30 has a convex portion 301 downwardly protruded therefrom and corresponding to the corresponding predetermined pressing region 100 and a surrounding portion 302 upwardly and outwardly extended from the convex portion 301. The pressing unit 4 includes a plurality of key bodies 41 respectively disposed inside the receiving spaces 200 for respectively contacting the deformable elastic elements 302 and a key layer 42 disposed on the frame layer 20 and the key bodies 41 for enclosing gaps g between the frame layer 20 and the key body 41.

### Twelfth Embodiment

Referring to FIG. 12, the twelfth embodiment of the instant disclosure provides a keyboard structure Z′ for increasing the pressing feeling of equilibrium. Comparing FIG. 12 with FIG. 11, the difference between the twelfth embodiment and the eleventh embodiment is as follows: the keyboard structure Z′ of the twelfth embodiment further comprises a light-guiding unit 5 and a light-reflecting unit 6. The light-guiding unit 5 includes a light-guiding layer 50 disposed on the bottom side of the switch circuit 10, and the light-reflecting unit 6 includes a light-reflecting layer 60 disposed on the bottom side of the light-guiding layer 50. Whereby, light beams (not shown) inside the light-guiding layer 50 can sequentially pass through the light-transmitting switch circuit 10 and the key body 41 and are transmitted to the key layer 42.

In conclusion, because the deformable elastic element 30 is reversely disposed on the switch circuit 10 and the deformable elastic element 30 is disposed between the switch circuit 10 and the key body 41, the contact area between the narrow bottom portion of the deformable elastic element 30 and the switch circuit 10 is smaller than the contact area between the wide top portion of the deformable elastic element 30 and the key body 41. Whereby, when a user uses a predetermined pressure to press upon the second key portion 411 of the key body 41, the predetermined pressure is balancedly or averagely pressed on the predetermined pressing region 100 of the switch circuit 10 through the deformable elastic element 30, for increasing the pressing feeling of equilibrium during the process of pressing the second key portion 411 of the key body 41.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A key structure for increasing the pressing feeling of equilibrium, comprising:
a switch circuit having a predetermined pressing region;
a frame layer disposed on the switch circuit, wherein the frame layer has a receiving space;
a deformable elastic element disposed on the switch circuit and received in the receiving space of the frame layer; and
a pressing unit including a key body contacting the deformable elastic element;
wherein the deformable elastic element is disposed between the switch circuit and the key body, and the contact area between the deformable elastic element and the switch circuit is smaller than the contact area between the deformable elastic element and the key body;
wherein when a predetermined pressure is pressed upon the pressing unit, the predetermined pressure is balancedly pressed on the predetermined pressing region of the switch circuit through the deformable elastic element.

2. The key structure of claim 1, wherein the switch circuit includes a first insulating layer, a second insulating layer disposed above the first insulating layer, and a plurality of spacers disposed between the first insulating layer and the second insulating layer, the first insulating layer has a first conductive portion disposed on the top side thereof, the second insulating layer has a second conductive portion disposed on the bottom side thereof and corresponding to the first conductive portion, and the predetermined pressing region of the switch circuit is disposed on the top side of the second insulating layer and corresponding to the second conductive portion.

3. The key structure of claim 1, wherein the deformable elastic element has a convex portion downwardly protruded therefrom and corresponding to the predetermined pressing region and a surrounding portion upwardly and outwardly extended from the convex portion, the deformable elastic element is a metal dome reversely disposed on the switch circuit, and the deformable elastic element has a wide top portion for contacting the key body and a narrow bottom portion opposite to the wide top portion for contacting the predetermined pressing region of the switch circuit, wherein the convex portion of the deformable element is a solid cylinder for abutting against the predetermined pressing region, and the surrounding portion of the deformable elastic element is a bowl elastic body for moving the convex portion to press the predetermined pressing region.

4. The key structure of claim 1, wherein the deformable elastic element has a convex portion downwardly protruded therefrom and corresponding to the predetermined pressing region and a surrounding portion upwardly and outwardly extended from the convex portion, the deformable elastic element is a rubber dome reversely disposed on the switch circuit, and the deformable elastic element has a wide top portion for contacting the key body and a narrow bottom portion opposite to the wide top portion for contacting the predetermined pressing region of the switch circuit, wherein the convex portion of the deformable element is a solid cylinder for abutting against the predetermined pressing region, and the surrounding portion of the deformable elastic element is a bowl elastic body for moving the convex portion to press the predetermined pressing region.

5. The key structure of claim 1, wherein the deformable elastic element has a convex portion downwardly protruded therefrom and corresponding to the predetermined pressing region and a surrounding portion upwardly and outwardly extended from the convex portion, the pressing unit includes a key layer disposed on the frame layer and the key body for enclosing a gap between the frame layer and the key body, the top side of the frame layer and the top side of the key body are substantially flushed with each other, and the key layer is connected to the frame layer and the key body through adhesive glue to form a single module component composed of the key layer, the frame layer and the key body.

6. The key structure of claim 5, wherein the key body has a first key portion for contacting the surrounding portion and a second key portion connected to the first key portion and disposed between the first key portion and the key layer, and the key layer has a pressing convex portion disposed on the top side thereof and corresponding to the second key portion.

7. The key structure of claim 5, further comprising:
a light-guiding unit including a light-guiding layer disposed on the bottom side of the switch circuit, wherein the switch circuit has at least one through opening passing therethrough and communicated with the receiving space; and
a light-reflecting unit including a light-reflecting layer disposed on the bottom side of the light-guiding layer;
wherein light beams inside the light-guiding layer sequentially pass through the switch circuit and the key body and are transmitted to the key layer.

8. A keyboard structure for increasing the pressing feeling of equilibrium, comprising:
a switch circuit having a plurality of predetermined pressing regions;
a frame layer disposed on the switch circuit, wherein the frame layer has a plurality of receiving spaces;
a plurality of deformable elastic elements disposed on the switch circuit and respectively received in the receiving spaces of the frame layer; and
a pressing unit including a plurality of key bodies respectively contacting the deformable elastic elements;
wherein each of the deformable elastic elements is disposed between the switch circuit and the corresponding key body, and the contact area between the deformable elastic element and the switch circuit is smaller than the contact area between the deformable elastic element and the key body;
wherein when a predetermined pressure is pressed upon the pressing unit, the predetermined pressure is balancedly pressed on the corresponding predetermined pressing region of the switch circuit through the corresponding deformable elastic element.

9. The keyboard structure of claim 8, wherein the switch circuit includes a first insulating layer, a second insulating layer disposed above the first insulating layer, and a plurality of spacers disposed between the first insulating layer and the second insulating layer, the first insulating layer has a plurality of first conductive portions disposed on the top side thereof, the second insulating layer has a plurality of second conductive portions disposed on the bottom side thereof and respectively corresponding to the first conductive portions, and the predetermined pressing regions of the switch circuit are disposed on the top side of the second insulating layer and respectively corresponding to the second conductive portions.

10. The keyboard structure of claim 8, wherein each of the deformable elastic elements has a convex portion downwardly protruded therefrom and corresponding to the corresponding predetermined pressing region and a surrounding portion upwardly and outwardly extended from the convex portion, each of the deformable elastic elements is a metal dome reversely disposed on the switch circuit, and each of the deformable elastic elements has a wide top portion for contacting the corresponding key body and a narrow bottom portion opposite to the wide top portion for contacting the corresponding predetermined pressing region of the switch circuit, wherein the convex portion of each deformable element is a solid cylinder for abutting against the corresponding predetermined pressing region, and the surrounding portion of each deformable elastic element is a bowl elastic body for moving the convex portion to press the corresponding predetermined pressing region.

11. The keyboard structure of claim 8, wherein each of the deformable elastic elements has a convex portion downwardly protruded therefrom and corresponding to the corresponding predetermined pressing region and a surrounding portion upwardly and outwardly extended from the convex portion, each of the deformable elastic elements is a rubber dome reversely disposed on the switch circuit, and each of the deformable elastic elements has a wide top portion for contacting the corresponding key body and a narrow bottom portion opposite to the wide top portion for contacting the corresponding predetermined pressing region of the switch circuit, wherein the convex portion of each deformable element is a solid cylinder for abutting against the corresponding predetermined pressing region, and the surrounding portion of each deformable elastic element is a bowl elastic body for moving the convex portion to press the corresponding predetermined pressing region.

12. The keyboard structure of claim 8, wherein each of the deformable elastic elements has a convex portion downwardly protruded therefrom and corresponding to the corresponding predetermined pressing region and a surrounding portion upwardly and outwardly extended from the convex portion, the pressing unit includes a key layer disposed on the frame layer and the key bodies for enclosing gaps between the frame layer and the key body, the top side of the frame layer and the top sides of the key bodies are substantially flushed with each other, and the key layer is connected to the frame layer and the key bodies through adhesive glue to form a single module component composed of the key layer, the frame layer and the key bodies.

13. The keyboard structure of claim 12, wherein each key body has a first key portion for contacting the corresponding surrounding portion and a second key portion connected to the first key portion and disposed between the first key portion and the key layer, and the key layer has a plurality of pressing convex portions disposed on the top side thereof and respectively corresponding to the second key portions of the key bodies.

14. The keyboard structure of claim 12, further comprising:
a light-guiding unit including a light-guiding layer disposed on the bottom side of the switch circuit, wherein the switch circuit has a plurality of through openings passing therethrough and respectively communicated with the receiving spaces; and
a light-reflecting unit including a light-reflecting layer disposed on the bottom side of the light-guiding layer;
wherein light beams inside the light-guiding layer sequentially pass through the switch circuit and the key bodies and are transmitted to the key layer.

15. A keyboard structure for increasing the pressing feeling of equilibrium, comprising:
a switch circuit having a plurality of predetermined pressing regions;
a frame layer disposed on the switch circuit, wherein the frame layer has a plurality of receiving spaces;
a plurality of deformable elastic elements disposed on the switch circuit and respectively received in the receiving spaces of the frame layer; and
a pressing unit including a plurality of key bodies respectively contacting the deformable elastic elements;
wherein each of the deformable elastic elements is disposed between the switch circuit and the corresponding key body, and the contact area between the deformable elastic element and the switch circuit is smaller than the contact area between the deformable elastic element and the key body;
wherein each of the deformable elastic elements is a metal dome or a rubber dome reversely disposed on the switch circuit, and each of the deformable elastic elements has a wide top portion for contacting the corresponding key body and a narrow bottom portion opposite to the wide top portion for contacting the corresponding predetermined pressing region of the switch circuit;
wherein when a predetermined pressure is pressed upon the pressing unit, the predetermined pressure is balancedly pressed on the corresponding predetermined pressing region of the switch circuit through the corresponding deformable elastic element.

16. The keyboard structure of claim 15, wherein the switch circuit includes a first insulating layer, a second insulating layer disposed above the first insulating layer, and a plurality of spacers disposed between the first insulating layer and the second insulating layer, the first insulating layer has a plurality of first conductive portions disposed on the top side thereof, the second insulating layer has a plurality of second conductive portions disposed on the bottom side thereof and respectively corresponding to the first conductive portions, and the predetermined pressing regions of the switch circuit are disposed on the top side of the second insulating layer and respectively corresponding to the second conductive portions.

17. The keyboard structure of claim 15, wherein each of the deformable elastic elements has a convex portion downwardly protruded therefrom and corresponding to the corresponding predetermined pressing region and a surrounding portion upwardly and outwardly extended from the convex portion, the convex portion of each deformable element is a solid cylinder for abutting against the corresponding predetermined pressing region, and the surrounding portion of each deformable elastic element is a bowl elastic body for moving the convex portion to press the corresponding predetermined pressing region.

18. The keyboard structure of claim 15, wherein each of the deformable elastic elements has a convex portion downwardly protruded therefrom and corresponding to the corresponding predetermined pressing region and a surrounding portion upwardly and outwardly extended from the convex portion, the pressing unit includes a key layer disposed on the frame layer and the key bodies for enclosing gaps between the frame layer and the key body, the top side of the frame layer and the top sides of the key bodies are substantially flushed with each other, and the key layer is connected to the frame layer and the key bodies through adhesive glue to form a single module component composed of the key layer, the frame layer and the key bodies.

19. The keyboard structure of claim 18, wherein each key body has a first key portion for contacting the corresponding surrounding portion and a second key portion connected to the first key portion and disposed between the first key portion and the key layer, and the key layer has a plurality of pressing convex portions disposed on the top side thereof and respectively corresponding to the second key portions of the key bodies.

20. The keyboard structure of claim 18, further comprising:
a light-guiding unit including a light-guiding layer disposed on the bottom side of the switch circuit, wherein the switch circuit has a plurality of through openings passing therethrough and respectively communicated with the receiving spaces; and
a light-reflecting unit including a light-reflecting layer disposed on the bottom side of the light-guiding layer;
wherein light beams inside the light-guiding layer sequentially pass through the switch circuit and the key bodies and are transmitted to the key layer.
